(19) United States
(12) Patent Application Publication
(10) Pub. No.: US 2025/0152477 A1
(43) Pub. Date: May 15, 2025

(54) SOLID MEDICATION DISPENSING DEVICE

(71) Applicant: Imam Abdulrahman Bin Faisal University, Dammam (SA)

(72) Inventors: Noof Waleed AL MASALAM, Dammam (SA); Najla ALRUMAIHI, Dammam (SA); Ruba ALKHALDI, Dammam (SA); Rahaf ALBAADI, Dammam (SA); Lama AL SHEHRI, Dammam (SA); Hala EL-WAKEEL, Dammam (SA); Khadeeja ANSARI, Dammam (SA)

(73) Assignee: Imam Abdulrahman Bin Faisal University, Dammam (SA)

(21) Appl. No.: 18/581,509

(22) Filed: Feb. 20, 2024

Related U.S. Application Data
(60) Provisional application No. 63/598,352, filed on Nov. 13, 2023.

(51) Int. Cl. A61J 7/04

(52) U.S. Cl. CPC A61J 7/0454; A61J 7/0436; A61J 7/0481

(57) ABSTRACT

A solid medication dispensing device that includes a medication carousel including a plurality of solid medication holding chambers, each configured to contain a single type of solid medication, a controllable opening cover configured to in a closed state prevent the solid medication from exiting holding chamber and in an open state allow the solid medication to exit a solid medication holding chamber, a removable storage compartment, and a controller. The device is configured to automatically dispense units of solid medication from the medication carousel to the removable storage compartment. The device can be configured to dispense one or more units of one or more solid medications to match a patient's total medication regimen.

### CROSS-REFERENCE TO RELATED APPLICATIONS

The present application claims priority to U.S. Provisional Application No. 63/598,352, filed Nov. 13, 2023, which is incorporated by reference in its entirety for all purposes.

### BACKGROUND OF THE INVENTION

### Field of the Invention

The present disclosure relates to an automated medication dispensing device and an automated medication dispensing system including the device.

### Discussion of the Background

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

People who are prescribed medication face a burden of continually remembering to take the appropriate amount of medication at the correct time. As the number of medications a person is prescribed increases, the complexity of remembering which medications to take and at which time rises dramatically. Unfortunately, many people who are prescribed multiple medications may suffer from decreased memory or other intellectual capacity and/or decreased dexterity or other movement capacity. One demographic particularly impacted is the elderly.

One method for helping patients take the proper medications in the proper amounts at the proper times is to pre-portion solid medications into containers. For example, medications can be placed into containers having compartments for particular times or days. However, pre-portioning is incredibly tedious and time-consuming. Further, manually filling containers can be prone to error, particularly with complex prescription regimens. Additionally, containers must be re-filled quite frequently. Larger containers that can serve a patient over a longer time are typically too large to be portable.

Accordingly, it is an objective of the present of the present disclosure to provide an automated medication dispensing device and method for dispensing medication.

### SUMMARY OF THE INVENTION

The present disclosure relates to a solid medication dispensing device, comprising a dispenser body that includes a body cover, a baseplate comprising a dispensing opening, a medication carousel including a plurality of solid medication holding chambers, each configured to contain a single type of solid medication, a controllable opening cover configured to in a closed state block the dispensing opening and thereby prevent a solid medication from exiting a solid medication holding chamber and in an open state allow a solid medication to exit a solid medication holding chamber, and a dispensing distributor disposed beneath the controllable opening cover; a removable storage compartment; and a controller, where the dispensing distributor is configured to direct solid medication from the dispensing opening to the removable storage compartment, the medication carousel is configured to rotate to position a solid medication holding chamber above the dispensing opening to permit dispensing of solid medication from that solid medication holding chamber during a dispensing action, and the controller is configured to control a rotation of the medication carousel and an action of the controllable opening cover during the dispensing action such that a solid medication output including one or more solid medications from one or more solid medication holding chambers is provided to the removable storage compartment.

In some embodiments, the solid medication dispensing device of claim 1, further comprises a filling distributor configured to receive a solid medication input and distribute the solid medication input to a solid medication holding chamber during a filling action, wherein the controller is configured to control to which solid medication hold chamber the solid medication input is distributed by controlling at least one selected from the group consisting of the filling distributor and the medication carousel.

In some embodiments, the removable storage compartment comprises a plurality of sub-compartments and the dispensing distributor is configured to direct a first portion of the solid medication output to a first sub-compartment and a second portion of the solid medication output to a second sub-compartment.

In some embodiments, the controller is configured to control an orientation of the dispensing distributor to direct the portion of the solid medication output to the sub-compartment.

In some embodiments, the solid medication dispensing device further comprises an electronic user input device configured to receive user input and provide instructions to the controller based on the user inputs.

In some embodiments, the controller is configured to receive an identity of a solid medication held in a solid medication holding chamber.

In some embodiments, the controller is configured to receive a size of a unit of a solid medication held in a solid medication holding chamber.

In some embodiments, the controller is configured to adjust a position of the controllable opening cover to allow only a single unit of the solid medication held in the solid medication holding chamber to be dispensed at a time during a dispensing action.

In some embodiments, the controller is configured to receive a dosage schedule of a solid medication held in a solid medication holding chamber.

In some embodiments, the controller is configured to receive a receive a medication regimen and dispense one or more solid medications to the removable storage compartment based on the medication regimen.

In some embodiments, the medication regimen is a daily regimen and the solid medication dispensing device dispenses to the removable storage compartment an entirety of the daily regimen at one time.

In some embodiments, the daily regimen is divided into one or more sub-regimens, each sub-regimen including at least one solid medication to be taken at a set time of day; the removable storage compartment comprises a plurality of sub-compartments; and each sub-regimen is dispensed to a different sub-compartment of the removable storage compartment.

In some embodiments, the medication regimen is a daily regimen and the solid medication dispensing device dispenses at a set time of day a sub-regimen including at least one solid medication to be taken at the set time of day.

In some embodiments, the body cover includes a filling opening configured to allow a solid medication to be supplied to the filling distributor.

In some embodiments, the body cover further comprises a blister pack opener.

The present disclosure also relates to a solid medication dispensing system, comprising the solid medication dispensing device; and a portable electronic user device, wherein the solid medication dispensing device is configured to receive user input from the portable electronic user device to provide an instruction to the controller based on the user input.

In some embodiments, the portable electronic user device is configured to provide an alert to a user.

In some embodiments, the portable electronic user device is configured to receive medication information including at least one of a size of a unit of a solid medication held in a solid medication holding chamber, a dosage schedule of a solid medication held in a solid medication holding chamber, and an identity of a solid medication held in a solid medication holding chamber; and transmit the medication information to the controller.

In some embodiments, the controller is configured to track a quantity of units of a solid medication held in a solid medication holding chamber and transmit to the portable electronic user device a low medication alert when the quantity is at a threshold value.

In some embodiments, the portable electronic user device is configured to transmit to the controller a dispensing signal that causes the controller to initiate a dispensing action.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows an expanded view of an exemplary embodiment of a solid medication dispensing device according to the present specification;

FIG. 2A shows a top-down schematic view of an exemplary embodiment of a solid medication dispensing device according to the present specification;

FIG. 2B shows a frontal schematic view of an exemplary embodiment of a solid medication dispensing device according to the present specification;

FIG. 2C shows a side-on schematic view of an exemplary embodiment of a solid medication dispensing device according to the present specification;

FIG. 3A shows a top-down schematic view of an exemplary embodiment of a removable storage compartment;

FIG. 3B shows a side-on schematic view of an exemplary embodiment of a removable storage compartment;

FIG. 3C shows an end-on schematic view of an exemplary embodiment of a removable storage compartment;

FIGS. 4A-4B show renderings of an exemplary embodiment of a solid medication dispensing device according to the present specification with FIG. 4A showing a side-on view and FIG. 4B showing a frontal view;

FIGS. 5A-5B show schematic depictions of an exemplary embodiment of solid medication holding chambers according to the present specification with FIG. 5A showing a three-quarters view and FIG. 5B showing a top-down view;

FIGS. 5C-5D show photographs of an exemplary embodiment of a medication carousel according to the present specification with FIG. 5C showing a carousel base and FIG. 5D showing a carousel having a plurality of solid medication holding chambers; and

FIGS. 6A-6E show exemplary possible methods of filling the solid medication holding chamber with a solid medication where FIGS. 6A-6C show a method of filling with a medication from a blister pack, FIG. 6D shows a method of filling with a medication from a medication bottle, and FIG. 6E shows a user entering information related to the medication added during the filling.

FIGS. 7A-7 shows an exemplary user-initiated dispensing action where FIG. 7A shows a user initiating a dispensing action on a touchscreen integral with the device, FIG. 7B shows the solid medications being distributed to various sub-compartments of the removable storage compartment, and FIG. 7C shows a user retrieving the removable storage compartment filled with the solid medications.

### DETAILED DESCRIPTION OF THE INVENTION

In the following description, it is understood that other embodiments may be used and structural and operational changes may be made without departure from the scope of the present embodiments disclosed herein.

### Definitions

As used herein the words “a” and “an” and the like carry the meaning of “one or more.”

As used herein, the terms “optional” or “optionally” means that the subsequently described event(s) can or cannot occur or the subsequently described component(s) may or may not be present (e.g., 0 wt. %).

### Solid Medication Dispensing Device

According to a first aspect, the present disclosure relates to a solid medication dispensing device. The solid medication dispensing device comprises a dispenser body, a removable storage compartment, and a controller.

In some embodiments, the dispenser body includes a body cover, a medication carousel including a plurality of solid medication holding chambers, each configured to contain a single type of solid medication, a baseplate that includes a dispensing opening, and a controllable opening cover.

In some embodiments, the body cover can be shaped and/or positioned to form a top of the solid medication dispensing device. In some embodiments, the body cover can optionally form one or more sides of the dispenser body. In general, the body cover can be formed of or include a single piece or multiple pieces. In some embodiments, the body cover is formed of a single contiguous piece of material that covers or forms the top of the solid medication dispensing device. In some embodiments, a single continuous piece can optionally form one or more sides of the dispenser body. In some embodiments, the body cover is formed from two or more pieces of material. In some embodiments, one such piece (e.g., a first piece) of the body cover forms the top of the solid medication dispensing device. In such an embodiment, other pieces can form other parts of the solid medication dispensing device, such as the sides. The sides can be formed from any number of pieces of solid material. For example, a second piece of material can form all of the sides of the solid medication dispensing device, a second piece of material can form a front side of the solid medication dispensing device while other sides (e.g., left side, right side, and back side) of the solid medication dispending device are formed from a third piece of material, or other similar divisions of the sides of the solid medication dispensing device. In some embodiments, the body cover is divided into separate portions that correlate with which portions of the solid medication dispensing device are covered. In some embodiments, the body cover includes a top portion formed from one or more pieces, a second section formed from one or more pieces, and a third section formed from one or more pieces. These sections can cover any number of sides of the solid medication dispensing device, but can be separated from each other in a vertical direction. In an embodiment, the body cover can include a carousel cover portion disposed about the medication carousel described below. In an embodiment, the body cover can include a distributor cover portion disposed below the carousel cover portion and about the dispensing distributor. In some embodiments, the distributor cover portion includes a removable storage compartment holder. The removable storage compartment holder can be a structure formed in or attached to the distributor cover portion that can secure the removable storage compartment during a dispensing action.

In general, the body cover can be constructed of any rigid material. Examples of rigid materials which may be used in the construction of the body cover include, but are not limited to, glass, wood, bamboo, rigid polymers such as acrylonitrile butadiene styrene (ABS), polyethylene, polypropylene, polyacrylate, polymethacrylate, poly(methyl methyacrylate), polyacrylic acid, poly amide, polybutylene, polycarbonate, polyvinylchloride, and the like, metal and metal alloys, and combinations of these. In some embodiments, the body cover is constructed in whole or part from a transparent material. That is, some or all of the body cover is transparent such that a user can visually inspect the interior of the solid medication dispensing device. In some embodiments, the body cover includes a carousel cover portion that is transparent. This may be advantageous for allowing a user to view the contents of the medications stored or held in the medication carousel to determine or confirm by inspection the presence of a solid medication therein or when a solid medication needs to be added or refilled.

In some embodiments, the body cover includes a filling opening configured to allow a solid medication to be supplied to the solid medication holding chambers. In some embodiments, the filling opening is configured to allow a solid medication to be supplied to a filling distributor as described below. Preferably, the filling opening is disposed at a top of the body cover. That is, the filling opening is positioned above the filling distributor and the solid medication holding chambers. In general, the filling opening can be any suitable shape. In some embodiments, the filling opening has an elongated slot-like shape. In some embodiments, the body cover includes a filling opening cover. The filling opening cover is preferably configured to reversibly cover the filling opening. Covering the filling opening may be useful for preventing contamination of solid medication stored in the solid medication dispensing device and/or for general cleanliness of the solid medication dispensing device. In some embodiments, the filling opening cover takes the form of a door, plate, or other flattened article that covers an entirety of the filling opening in a closed state. The door, plate, or other flattened article may be moved from the closed state to an open state by a hinge pivot motion, a rotation motion, a sliding motion, or some combination of these.

In some embodiments, the filling opening cover takes the form of a door which slides to open the filling opening. In such an embodiment, the door may be slid to any suitable position such that the filling opening is open to a width that is less than or equal to a total width of the filling opening. In some embodiments, the door may be equipped with an indexed sliding mechanism such that the door can be slid to set, indexed positions to provide a filling opening with a set width. Such a set width can be based on common sizes of solid medication units and/or packaging (e.g., a blister pack). In some embodiments, the filling opening cover can be operated (i.e., opened and closed) manually by a user. In some embodiments, the filling opening cover can be operated by the controller as described below.

In some embodiments, the body cover further comprises a blister pack opener. In some embodiments, the blister pack opener comprises a raised ridge formed on a side of the filling opening. The raised ridge may be advantageous for applying pressure to a side of a row of solid medication units contained in a blister pack. In some embodiments, the filling opening cover comprises a raised ridge disposed on a side of the opening cover proximal to a corresponding raised ridge on the filling opening. Such a raised ridge on the filling opening cover may be advantageous for applying pressure to a side of a row of solid medication units contained in a blister pack. In some embodiments a pair of raised ridges, one on the body cover on a side of the filling opening and the other on the filling opening cover, define a valley advantageous for directing pressure applied from above into pushing the units of solid medication out of the blister pack. In some embodiments, the blister pack opener comprises a pushing handle. The pushing handle can be used to apply a pressure to push the units of solid medication out of the blister pack. The pushing handle can be advantageous for decreasing the amount of mechanical force that a user needs to apply by hand. This may be particularly advantageous for elderly, less dexterous or less strong users.

In some embodiments, the body cover is angled, having a higher portion and a lower portion. In some embodiments, the body cover includes an angled plane (e.g., an angled flat portion). In some embodiments, the filling opening is arranged on the angled plane such that the filling opening has a higher portion arranged on the higher portion of the angled plane and a lower portion arranged on the lower portion of the angled plane. Preferably, the lower portion of the angled plane is still disposed above the filling distributor and solid medication holding chambers.

The solid medication dispensing device is configured to hold one or more solid medications (e.g., pills, tablets, capsules, etc.) in a plurality of solid medication holding chambers. The solid medication holding chambers may be referred to as “holding chambers”, “medication holding chambers”, or other similar term. Each solid medication holding chamber is configured to hold a solid medication. Preferably, a solid medication holding chamber holds only one type of solid medication. A type of solid medication can be defined by the identity of the medication such as an active ingredient, the form of a medication (e.g., pill vs tablet vs capsule, etc.), the dosage of the medication, the brand of medication, or any other similar property or factor of the solid medication. In general, the solid medication holding chamber can be any suitable size and/or shape. In some embodiments, the solid medication holding chamber has a cross-sectional shape defining an interior volume. In some embodiments, the cross-sectional shape is devoid of interior angles or corners. The absence of such interior angles or corners may be advantageous for preventing or avoiding the solid medication from becoming stuck, wedged, lodged, or otherwise prevented from exiting the solid medication holding chamber. In some embodiments, the solid medication holding chamber has an elliptical cross-section. In some embodiments, the solid medication holding chamber has an ovoid cross-section. The ovoid cross-section may have a first cross-sectional end which is larger than a second cross-sectional end.

Preferably, the solid medication holding chamber has an open top. That is, there is no top face present. The lack of a top face may be advantageous for filling the holding chamber during a filling action. In some embodiments, the solid medication holding chamber comprises a bottom face. The bottom face may be useful for ensuring that the solid medication holding chamber can hold the solid medication. The bottom face preferably has a holding chamber exit opening through which units of the solid medication can pass to exit the holding chamber during a dispensing action. In some embodiments, the solid medication holding chamber has an angled bottom face. The angled bottom face is preferably oriented such that all units of a solid medication which are placed in the solid medication holding chamber are directed to the holding chamber exit opening. In some embodiments, the holding chamber exit opening has a slot shape. In some embodiments, the slot shape has rounded ends. Rounded ends may be advantageous for preventing or avoiding the solid medication from becoming stuck, wedged, lodged, or otherwise prevented from exiting the solid medication holding chamber.

The solid medication holding chambers are arranged into a medication carousel. In some embodiments, the medication carousel comprises equally spaced solid medication holding chambers. Preferably, the medication carousel is rotationally symmetric. That is, the medication carousel can be rotated to position a single holding chamber in a dispensing position that allows the solid medication therein to be dispensed. The medication carousel can then be rotated to a different position to allow a different holding chamber to be placed in the dispensing position. In embodiments where the solid medication holding chamber have an ovoid cross-section, the first cross-sectional end which is larger may be arranged toward the exterior of the medication carousel and the smaller second cross-sectional end can be arranged toward the interior of the medication carousel.

The holding chambers can be arranged on a carousel base. Preferably, the carousel base is substantially circular. In some embodiments, the medication carousel can be rotated by rotation of the carousel base. In some embodiments, the carousel base comprises a plurality of holding chamber securing features. Such features can be, for example, indentations and/or projections that receive and/or are received by the holding chambers to securely hold the holding chambers. In some embodiments, the holding chambers can be devoid of a bottom face. In such an embodiment, the carousel base takes the place of the bottom face. In such an embodiment, the holding chamber securing feature can be angled. Such an angled holding chamber securing feature is preferably oriented such that all units of a solid medication which are placed in the solid medication holding chamber are directed to a carousel base opening. In some embodiments, the carousel base comprises a plurality of carousel base openings through which units of the solid medication can pass. During a dispensing action, a unit of a solid medication can pass through the holding chamber exit opening, then through a carousel base opening. Preferably, the carousel base includes a single carousel base opening for every holding chamber the carousel base is configured to support. In some embodiments, the solid medication dispensing device comprises a carousel rotation motor connected to the carousel base. The carousel rotation motor is preferably configured to rotate the medication carousel.

In some embodiments, the solid medication dispensing device further comprises a filling distributor configured to receive a solid medication input and distribute the solid medication input to a solid medication holding chamber during a filling action. The filling distributor is preferably disposed beneath the filling opening of the body cover such that solid medication introduced into the filling opening falls to the filling distributor and a totality of the solid medication introduced is directed to a holding chamber. In some embodiments, the controller is configured to control to which solid medication hold chamber the solid medication input is distributed by controlling at least one selected from the group consisting of the filling distributor and the medication carousel. In some embodiments, the filling distributor has a tapered or funnel shape. Such a shape may be advantageous for ensuring that a totality of the solid medications added during a filling action are directed to a single medication holding chamber. Such a shape may permit the filling opening to be larger than a diameter or cross-sectional area of the medication holding chambers while still allowing reliable filling of the holding chambers. A larger filling opening may be advantageous to less dexterous users for ease of filling the solid medication dispensing device.

The solid medication dispensing device includes a baseplate that includes a dispensing opening. The dispensing opening can be any suitable shape. The dispensing opening allows a solid medication to exit a holding chamber only when that holding chamber is positioned above the dispensing opening. That is, a solid medication can be dispensed from a particular holding chamber by rotating the medication carousel to position the holding chamber exit opening over the dispensing opening. A position in which a holding chamber exit opening is aligned with the dispensing opening of the baseplate can be referred to as the “dispensing position”. In general, the baseplate can have any suitable shape. In some embodiments, the baseplate has substantially the same shape as the carousel base described above.

The dispenser body also includes a controllable opening cover. The controllable opening cover is configured to in a closed state block the dispensing opening and thereby prevent a solid medication from exiting a solid medication holding chamber and in an open state allow a solid medication to exit a solid medication holding chamber. In some embodiments, the controllable opening cover takes the form of a disc, plate, or other flattened article. In such an embodiment, the disc, plate, or other flattened article includes a cover slot through which solid medication can pass during a dispensing action. In some embodiments, the controllable opening cover also includes a medication stopper. The medication stopper can function to prevent uncontrolled exit of solid medication from the holding chamber. In some embodiments, the medication stopper can take the form of a disc, plate, or other flattened article. In such an embodiment, the disc, plate, or other flattened article preferably does not have an opening through which solid medication can pass. In some embodiments, the medication stopper can be connected to or integral with the dispensing distributor described below.

In the open state, the cover slot can be aligned with the holding chamber exit opening to allow a single unit of solid medication to exit the holding chamber into the cover slot. That single unit is stopped by the medication stopper and retained within the cover slot. That single unit also prevents the entry of other units into the cover slot such that only a single unit can be retained within the cover slot at a time. The controllable opening cover can then be toggled to the closed position to close the holding chamber exit opening and thereby prevent solid medication from exiting the holding chamber. The closed position can also position the cover slot away from the medication stopper, thereby allowing the single unit of solid medication contained therein to fall out of the cover slot. This way, toggling the controllable opening cover from the closed state to the open state and back to the closed state allows only a single unit of a solid medication that is contained within a holding chamber positioned above the dispensing opening to be first loaded into the cover slot, then unloaded from the cover slot for dispensing. In some embodiments, the controller is configured to adjust a position of the controllable opening cover to allow only a single unit of the solid medication held in the solid medication holding chamber to be dispensed at a time during a dispensing action.

In some embodiments, a separation between the controllable opening cover and the medication stopper is adjustable. This way, a vertical size of the opening slot can be controlled to allow for accommodation of different sizes of units of solid medication. The vertical size of the opening slot can be adjusted so as to ensure that only a single unit of the solid medication is contained within the opening slot at a time. Therefore, a single toggling of the state of the controllable opening cover described above is ensured to dispense only a single unit of the solid medication. In such embodiments, adjustment of the separation between the controllable opening cover and the medication stopper is performed by or controlled by the controller. In some embodiments, the controller can adjust the separation based on a size of the solid medication to be dispensed. The size of the solid medication can be stored by the controller and adjustment can be made automatically when that solid medication is to be dispensed. In some embodiments, the toggling of the controllable opening cover is achieved by operation of an opening cover motor. In some embodiments, the adjustment of the separation between the controllable opening cover and the medication stopper is achieved by operation of a separation adjustment motor.

The dispenser body also includes a dispensing distributor disposed beneath the controllable opening cover. The dispensing distributor is configured to receive a unit of solid medication from the cover slot and convey, direct, or otherwise distribute that unit to a specific portion of the removable storage compartment. In some embodiments, the dispensing distributor takes the form of an angled tube, pipe, trough, or other similar shape. In some embodiments, the dispensing distributor or a portion thereof forms the medication stopper described above. In some embodiments, the dispensing distributor is movable. Such moving can change the orientation of the dispensing distributor to direct the portion of the solid medication output to the sub-compartment. Moving the dispensing distributor along a first axis can direct the unit of solid medication to the specific portion of the removable storage compartment. For example, the dispensing distributor can be pivotable. A pivotable dispensing distributor can have a fixed end disposed near the controllable opening cover and a free end near the removable storage compartment. The pivotable dispensing distributor is configured to dispense a unit of solid medication to a specific portion of the removable storage compartment by pivoting. In some embodiments, the dispensing distributor is configured to move along a second axis substantially perpendicular to the first axis. Motion along the second axis can allow for distribution of the solid medication to a specific portion of a removable storage compartment that has a two-dimensional grid of sub-compartments as described below. In some embodiments, the motion of the dispensing distributor is achieved by operation of a dispensing distributor motor.

The removable storage compartment is configured to receive solid medication distributed from the dispenser body. In some embodiments, the removable storage compartment comprises a plurality of sub-compartments. In such embodiments, each sub-compartment is preferably separate such that solid medication placed in one sub-compartment does not mix with solid medication placed in another sub-compartment. In such embodiments, the dispensing distributor is configured to direct a first portion of a solid medication output to a first sub-compartment and a second portion of the solid medication output to a second sub-compartment. In general, there is no limit on the number of sub-compartments that can be present in the removable storage compartment. In some embodiments, the removable storage compartment is formed of only one sub-compartment that forms the entirety of the removable storage compartment. In some embodiments, the removable storage compartment is a daily compartment and comprises four sub-compartments. Each of the four sub-compartments can correspond to a particular time of day, such as morning, noon, evening, and night, or other such daily temporal divisions. In some embodiments, the removable storage compartment is a weekly compartment and comprises seven sub-compartments. Each of the seven sub-compartments can correspond to a particular day of the week. In such embodiments, the sub-compartments can be arranged in single line. That is, each sub-compartment differs only by a position along a single axis. In some embodiments, the removable storage compartment can comprise sub-compartments arranged in a grid. That is, the sub-compartments can differ by a position along two axes. For example, the removable storage compartment can include a first row of seven sub-compartments corresponding to a first week and a second row of seven sub-compartments corresponding to a second week. Such a removable storage compartment can include two, three, or four such rows. In another example, the removable storage compartment can include a first row of seven sub-compartments corresponding to a first time of day for each day in a week (e.g., morning) and a second row of seven sub-compartments corresponding to a second time of day for each day in a week (e.g., afternoon). In general, such a removable storage compartment can include any number of such rows. A solid medication can be distributed to a specific sub-compartment during a dispensing or filling action by controlling an orientation of the dispensing distributor as described above.

In some embodiments, the solid medication dispensing device further comprises a distributing adapter. The distributing adapter can be disposed at or near an end of the dispensing distributor. In some embodiments, the distributing adapter is configured to facilitate transfer of the solid medication from the dispensing distributor to the removable storage compartment. In some embodiments, the distributing adapter can have a channel through which the solid medication passes. In general, the distributing adapter can have any suitable number of channels. In some embodiments, the distributing adapter can have a number of channels that matches a number of sub-compartments of the removable storage compartment. For example, a distributing adapter configured to be used with a removable storage compartment having four sub-compartments can have four channels. Each channel can correspond to and facilitate proper delivery of the solid medication to a specific sub-compartment. The distributing adapter can be useful for ensuring that a solid medication unit intended to be distributed to a specific sub-compartment is not accidentally placed in a different sub-compartment. In some embodiments, the dispensing distributor is configured to deliver a solid medication unit to a portion of the distributing adapter that corresponds to a specific sub-compartment of the removable storage compartment.

In some embodiments, the removable storage compartment comprises a storage compartment cover. The storage compartment cover is configured to attach to, be disposed, or receive the removable storage compartment and cover every sub-compartment such that solid medication contained within is securely held within each sub-compartment.

### Controller

In some embodiments, the controller is configured to control a rotation of the medication carousel and an action of the controllable opening cover during a dispensing action such that a solid medication output including one or more solid medications from one or more solid medication holding chambers is provided to the removable storage compartment. In some embodiments, the controller is also configured to control the filling opening cover. That is, the filling open cover can be opened and closed by the controller. For example, the controller can operate a filling opening cover motor to open and/or close the filling opening cover. In some embodiments, the controller is configured to control a separation between the controllable opening cover and the medication stopper. Such a separation can be based off a size of a unit of solid medication. In some embodiments, the controller is configured to control an orientation of the dispensing distributor to direct the portion of the solid medication output to the sub-compartment. In some embodiments, the controller is configured to control to which solid medication hold chamber the solid medication input is distributed by controlling at least one selected from the group consisting of the filling distributor and the medication carousel.

In some embodiments, the controller is configured to track information related to which solid medication is contained within which holding chamber. Such information related to which solid medication is contained within which holding chamber is necessary to automatically dispense the solid medication. The information related to which solid medication can be or include identity information such as an active ingredient, the form of a medication (e.g., pill vs tablet vs capsule, etc.), the dosage of the medication, the brand of medication, or any other similar property or factor of the solid medication. In some embodiments, the controller is configured to receive an identity of a solid medication held in a solid medication holding chamber. Such information can be entered by a user, transmitted from another device, or automatically retrieved by the controller from another device. For example, when a user fills a holding chamber, that user can manually enter the identity of the solid medication being placed into that holding chamber. In another example, the user can image or scan the solid medication, a prescription, a pharmacy information package, or some other similar article using a scanner or camera included in the solid medication dispensing device. The imaging or scanning can input the information directly, for example through use of a barcode, 2D barcode, or other similar visual information encoding scheme. The imaging or scanning can initiate an information retrieval process in which the information is retrieved from another device. For example, the solid medication dispensing device can image or scan an article that encodes some identifier of the solid medication such that the controller can retrieve the necessary information about the solid medication from a remote database. The remote database can be accessed, for example, via some connection to a remove device via the internet. In another example, the user can input, access, or retrieve the identity of the solid medication using their smartphone or other electronic device, which then transmits the identity of the solid medication to the controller. For example, prescription information can be accessed on the user's smartphone then transmitted to the controller via a connection between the controller and the smartphone. Such a connection can be provided by a wired connection or a wireless connection via a suitable wireless communication protocol (e.g., Wi-Fi, Bluetooth, etc.).

In some embodiments, the controller is configured to receive a size of a unit of a solid medication held in a solid medication holding chamber. Such size information can be input by a user, for example, by manually entering the size information, scanning the solid medication, a prescription, a pharmacy information package, or some other similar article using a scanner or camera included in the solid medication dispensing device, inputting, accessing, or retrieving the identity of the solid medication using their smartphone or other electronic device, which then transmits the identity of the solid medication to the controller as described above. In some embodiments, the controller is configured to, upon receiving identity information of a solid medication, automatically retrieve size information of that solid medication from a database. The database may be located in an electronic information storage device that is integral with the solid medication dispensing device or an electronic information storage device that is remote to and connected to the solid medication dispensing device, for example a server connected via the internet. Such a connection can be provided by a wired connection or a wireless connection via a suitable wireless communication protocol (e.g., Wi-Fi, Bluetooth, etc.).

In some embodiments, the controller is configured to adjust a position of the controllable opening cover to allow only a single unit of the solid medication held in the solid medication holding chamber to be dispensed at a time during a dispensing action. Such adjustment can be made automatically based on the size information of the solid medication described above. Such adjusting of the position of the controllable opening cover and/or medication stopper can be performed automatically by the controller based on the size information described above.

In some embodiments, the controller is configured to receive a dosage schedule of a solid medication held in a solid medication holding chamber. In some embodiments, the controller is configured to dispense a solid medication or combination of solid medications at a particular time based on the dosage schedule. In general, the dosage schedule can be input or retrieved by the controller similar to the information related to which solid medication is contained within which holding chamber and/or size information as described above.

In some embodiments, the controller is configured to receive a receive a medication regimen and dispense one or more solid medications to the removable storage compartment based on the medication regimen. In some embodiments, the medication regimen is a daily regimen and the solid medication dispensing device dispenses to the removable storage compartment an entirety of the daily regimen at one time. In some embodiments, the daily regimen is divided into one or more sub-regimens, each sub-regimen including at least one solid medication to be taken at a set time of day. In such an embodiment, the removable storage compartment comprises a plurality of sub-compartments, and each sub-regimen is dispensed to a different sub-compartment of the removable storage compartment. In some embodiments, the medication regimen is a daily regimen and the solid medication dispensing device dispenses at a set time of day a sub-regimen including at least one solid medication to be taken at the set time of day. In some embodiments, the regimen is a weekly regimen divided into one or more sub-regimens. The sub-regimens of the weekly regimen may be days or specific times of day. In general, the dosage schedule can be input or retrieved by the controller similar to the information related to which solid medication is contained within which holding chamber and/or size information as described above.

In some embodiments, the solid medication dispensing device comprises a scanner, camera, or other electronic optical information input device. Such a device can be integral with the solid medication dispensing device or external to and connected to the solid medication dispensing device. The electronic optical information input device is configured to receive optical information (e.g., a barcode, two-dimensional bar code such as a QR code, an image or picture, or some combination of these) and provide instructions to the controller based on the optical information. Such optical information can be, include, or correspond to solid medication identity information, size information, dosage information, regimen information, or some combination thereof, as described above.

In some embodiments, the solid medication dispensing device comprises an electronic user input device. The electronic user input device can be any suitable such device known to one of ordinary skill in the art. The electronic user input device can include a screen. For example, the electronic user input device can be a keypad and/or touchscreen. The electronic user input device is configured to receive user input and provide instructions to the controller based on the user inputs. Such user inputs can be, include, or correspond to solid medication identity information, size information, dosage information, regimen information, or some combination thereof, as described above.

In some embodiments, the controller is configured to provide an alert to a user. In general, the alert can be any suitable notification. Such a notification can bring to the user's attention some information related to the medication, regimen, device, or combination of these. In some embodiments, a notification can require user input or be related to a task or activity that requires user input. For example, a notification can be provided to remind a user that it is time to take one or more units of solid medication. Such a notification can be automatically provided by the controller based on the regimen. In another example, a notification can be provided to place the removable storage compartment in a position for dispensing. In another example, a notification can be provided to remind a user to refill their prescription. In another example, a notification can be provided to alert the user to a low level of a solid medication remaining in a holding chamber (e.g., a “low medication alert”). In some embodiments, the controller can track a quantity of units of solid medication held in solid medication holding chamber. Such a quantity can be used to determine when to provide the low medication alert. In some embodiments, the quantity can be tracked based on an input quantity provided to the controller during filling and updated when a unit of the solid medication is dispensed. When the quantity reaches a threshold value, the low medication alert can be provided.

In some embodiments, the notification can be generated by the controller. In some embodiments, the notification can be provided to the user on a screen or touchscreen which is integral with the solid medication dispensing device. In some embodiments, the notification can be provided to the user on an electronic device connected to the solid medication dispensing device. For example, the user's smartphone can be wirelessly connected to the solid medication dispensing device such that a notification can be provided to the user via the smartphone. In some embodiments, a notification can be provided even when the user's electronic device (e.g., smartphone) is not currently connected to the solid medication dispensing device. For example, a connection between the smartphone and the solid medication dispensing device can transfer information related to future notifications to the user's smartphone (e.g., future medication reminders based on the regimen). Such pre-loaded notifications can be configured to be displayed by the smartphone under appropriate conditions, such as at a certain time.

In some embodiments, the controller is configured to adjust the medication carousel and/or the filling distributor during a filling action. The adjustment of these components can ensure that during a filling action the solid medication being input is delivered to and stored in a particular holding chamber. In some embodiments, the controller is configured to adjust the medication carousel, medication stopper, and dispensing distributor during a dispensing action. The adjustment of these components can ensure that during a dispensing action, the appropriate type and number of units of solid medication are dispensed and that the units are dispensed to the proper sub-compartment if necessary. In some embodiments, the adjustments are made based on the information about the solid medication as described above.

In some embodiments, the controller can initiate a dispensing action in response to a user input. In general, that user input can be provided to the controller in any suitable way. In an example, the user can initiate a dispensing by interacting with the user input device integrated with the solid medication dispensing device as described above. In an example, the user can initiate a dispensing by providing an input to a user electronic device (e.g., a smartphone) that is connected to the solid medication dispensing device as described above. The user electronic device can then transmit to the controller a signal that cause the controller to initiate the dispensing action.

In some embodiments, the controller can initiate a dispensing action automatically. That is, the controller can dispense one or more units of one or more solid medications without the dispensing being initiated by a user input. In some embodiments, the automatic initiation can be based on the regimen. For example, the controller can, based on the regimen, dispense a single dose of one or more solid medications when a user is scheduled to take the dose. In another example, the controller can dispense one or more doses of one or more solid medications before the user is schedule to take them. The doses can be provided to different sub-compartments of the removable storage compartment as described above. For example, the controller can dispense to a removable storage compartment having four different sub-compartments corresponding to different times of the day the four different sub-regiments that correspond to those times of the day. This way, the solid medication dispensing device can pre-fill the removable storage compartment with all of the medication that the user needs for the day such that the user does not need to select the proper solid medications to take at any given time. Each sub-compartment can be filled with the appropriate type and number of solid medication units to be taken at its corresponding time.

### Solid Medication Dispensing System

In some embodiments, the solid medication dispensing device and a portable electronic user device together form a solid medication dispensing system. In some embodiments, the solid medication dispensing device is configured to receive user input from the portable electronic user device to provide an instruction to the controller based on the user input. In some embodiments, the portable electronic user device is configured to provide an alert to a user as described above. In some embodiments, the portable electronic user device is configured to receive medication information including at least one of a size of a unit of a solid medication held in a solid medication holding chamber, a dosage schedule of a solid medication held in a solid medication holding chamber, and an identity of a solid medication held in a solid medication holding chamber and transmit the medication information to the controller as described above. In some embodiments, the controller is configured to track a quantity of units of a solid medication held in a solid medication holding chamber and transmit to the portable electronic user device a low medication alert when the quantity is at a threshold value as described above. In some embodiments, the portable electronic user device is configured to transmit to the controller a dispensing signal that causes the controller to initiate a dispensing action as described above.

In some embodiments, the connection between the portable electronic user device and the solid medication dispensing device is controlled by a suitable application or piece of software configured to run on the portable user electronic device. For example, the user portable electronic device can be a smartphone and the software can be a smartphone app. Such a piece of software or app can control the transfer of information between the portable electronic user device and the solid medication dispensing device. Such a piece of software can provide the user a convenient interface for controlling the solid medication dispensing device using the portable electronic user device. In some embodiments, the portable electronic user device can be used to provide notifications to the user even when not connected to the solid medication dispensing device. For example, a smartphone running a smartphone app can store the regimen information and provide a reminder to the user to take a solid medication at a particular time. This may be advantageous when used with a removable storage compartment. This way, a user can be reminded to take a specific dose (e.g., a noon dose) stored in the removable storage compartment at or around noon even when away from the solid medication dispensing device. In another example, the smartphone app can track a user's medication compliance. The user can indicate to the smartphone app that they have taken the dose. The smartphone app can store the user's medication history (e.g., what medications have been taken and when). The medication history can be transmitted to the solid medication dispensing device, which can update relevant information stored therein. In an example, the medication history can be used to update a regimen or sub-regimen. If a user misses a dose, for example, the solid medication dispensing device can skip that dose such that the user is not accidentally provided additional units of solid medication.

For illustration purposes, an exemplary use case of the solid medication dispensing device and/or system is described here according to an embodiment of the present disclosure. A user can be prescribed a total medication regimen including one or more medications to be taken at some frequency. For example, a user can be instructed to take a first medication once per day and a second medication twice per day. The user can fill the solid medication dispensing device by placing the first medication in a first holding chamber and a second medication in a second holding chamber. The user can then input to the solid medication dispensing device which medication is in which holding chamber using either a dedicated touchscreen on the device or using another device like their smartphone. These steps can be performed in any suitable order. For example, the user can configure the solid medication dispensing device to fill a first holding chamber with the first medication, provide suitable information to the controller about the first medication, then proceed to filling the second holding chamber with the second medication. The user can alternatively or additionally select a first holding chamber to be filled and the controller can adjust the mediation carousel and/or filling distributor to direct the solid medication being input into the solid medication dispensing device to the first holding chamber.

Then, the solid medication dispensing device can automatically perform a dispensing action. This dispensing action can provide one or more of the solid medications to the removable storage compartment. For example, when it is time for a user to take the first medication, the solid medication dispensing device can automatically dispense the appropriate number of units of the first medication corresponding to a dose appropriate for that time. The solid medication dispensing device can automatically position the first holding chamber containing the first medication over the dispensing opening by rotating the medication carousel. Then, the solid medication dispensing device can toggle the controllable opening cover to dispense the appropriate number of units of the first medication one at a time.

When it is time for the user to take both the first and second medications, the solid medication dispensing device can automatically dispense both the first and second medications. The solid medication dispensing device can dispense the first medication as described above. Then, while the controllable opening cover is in the closed state, the medication carousel can be rotated to place the second holding chamber containing the second medication above the dispensing opening. Then, the solid medication dispensing device can toggle the controllable opening cover to dispense the appropriate number of units of the second medication, one at a time, corresponding to an appropriate dosage of the second medication.

The solid medication dispensing device can automatically dispense one or more solid medications at a time appropriate for the user to take said medication(s) based on the dosage schedule and/or medication regimen. The solid medication dispensing device can alternatively or additionally automatically dispense a total amount of one or more solid medications to be taken in a given time period (e.g., in a day) to the removable storage compartment. For example, the solid medication dispensing device can automatically distribute the single dose of the first medication and both doses of the second medication to the removable storage compartment in a single dispensing action. That is, the solid medication dispensing device can “fill” the removable storage compartment with the appropriate number of units of the one or more solid medications for the entire day at a time (i.e., a totality of the solid medications to be taken that day). Individual doses of the solid medication(s) can be distributed to individual sub-compartments of the removable storage compartment. For example, a morning dose of the second medication and the single dose of the first medication can be dispensed to a “morning” sub-compartment and the evening dose of the second medication can be dispensed to an “evening” sub-compartment. This way, the entirety of a user's daily medications can be automatically dispensed to the removable storage compartment. Such dispensing can automatically place the correct number of units of each medication in the appropriate sub-compartment for a user's entire daily medication needs.

Similarly, for a weekly regimen, the solid medication dispensing device can automatically dispense an entire week of medications in the appropriate doses and organized into appropriate time periods. The time periods may be days (e.g., one sub-compartment for each day) or may be specific times of each day (e.g., one sub-compartment for each of Monday morning, Monday afternoon, Monday evening, Monday night, Tuesday morning, Tuesday afternoon, Tuesday evening, Tuesday night, etc.). The medication(s) to be taken at the specific time periods may be referred to as “sub-regimens” or other similar term. For example, a sub-regimen can be a single day or portion of a day.

For accurate dispensing, the controller can be configured with the exact identity, dosage, schedule, and/or other information of each medication the user is prescribed. Such information can be provided to the controller as described above. For example, the user can manually enter such information to the controller via a touch screen, manually enter such information into their smartphone and transfer to the controller via some wireless communication protocol (e.g., Wi-Fi, Bluetooth, etc.), or manually enter some information and the controller can automatically retrieve other information from some internal or external source (e.g., the controller can look up the size of a particular tablet of medication from an internet database).

The solid medication dispensing device can also be configured to dispense a solid medication or medication regimen based on a user input. For example, a user can provide an instruction to the solid medication dispensing device to dispense a medication, sub-regimen, or regimen. This may be referred to as “manual” or “user-initiated” dispensing.

The controller can also track how many units of a solid medication were input to a holding chamber and how many units have been dispensed from the holding chamber. That is, the controller can track a number of units of a solid medication in a holding chamber. When the number of units of solid medication in a holding chamber reaches a threshold value (e.g., a low medication value), the controller can present an alert to the user (e.g., a “low medication” alert). This may be advantageous for reminding a user to refill a prescription and/or refill the holding chamber. Such an alert can be displayed on a screen connected to the solid medication dispensing device and/or delivered to another device such as a smartphone.

The examples below are intended to further illustrate protocols for constructing the solid medication dispensing device and system of the present disclosure and are not intended to limit the scope of the claims.

Where a numerical limit or range is stated herein, the endpoints are included. Also, all values and subranges within a numerical limit or range are specifically included as if explicitly written out.

Obviously, numerous modifications and variations of the present invention are possible in light of the above teachings. It is therefore to be understood that, within the scope of the appended claims, the invention may be practiced otherwise than as specifically described herein.

### Examples

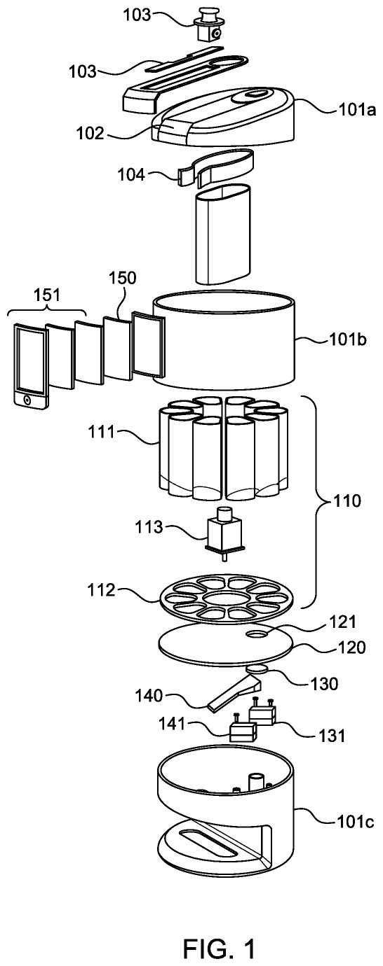

FIG. 1 shows a solid medication dispensing device according to an exemplary embodiment. The solid medication dispensing device is depicted in an expanded form so as to better show the constituent parts and their relationships to each other. The exemplary solid medication dispensing device depicted in FIG. 1 includes a body cover. The body cover is depicted as having three pieces, a body cover top portion 101a, a carousel cover portion 101b, and a dispenser cover portion 101c. The body cover top portion 101a includes a filling opening 102 as well as a blister pack opener with pushing handle 103. Directly beneath the filling opening 102 of the body cover top portion 101a is a filling distributor 104 that is positioned to direct solid medications introduced through the filling opening 102. The exemplary solid medication dispending device also includes a medication carousel 110. The medication carousel includes a plurality of holding chambers 111, a carousel base 112, and a carousel motor 113. The holding chambers are held and supported by the carousel base 112. The carousel motor 113 is configured to rotate the medication carousel. Directly below the medication carousel 110 is a baseplate 120 that includes a dispensing opening 121. Rotation of the medication carousel can position a holding chamber 111 to receive a solid medication input from the filling distributor 104. Rotation of the medication carousel can also position a holding chamber 111 to be aligned with the dispensing opening 121 for dispensing the solid medication held in that holding chamber. Directly below the dispensing opening 121 of the baseplate 120 is a controllable opening cover 130. The controllable opening cover 130 is shown as a circular plate that matches the shape of the dispensing opening 121. The controllable opening cover 130 includes a cover slot that allows for dispensing of a single unit of a solid medication at a time. Motion of the controllable opening cover 130 is achieved by a controllable opening cover motor 131. Directly below the controllable opening cover is the dispensing distributor 140. Motion of the dispensing distributor 140 (e.g., pivoting) is achieved a dispensing distributor motor 141. In the exemplary embodiment depicted in FIG. 1, the solid medication units travel from the top of the device (e.g., the filling opening) to the bottom of the device (e.g., the dispensing distributor) solely by gravity. The motion (e.g., falling) of the solid medication is arrested and controlled by the various components of the device described above such that a single unit of any given solid medication can be achieved through proper control of the motion (e.g., falling) of the solid medication unit. Such control of the descent can be achieved by precise operation of the various components described above.

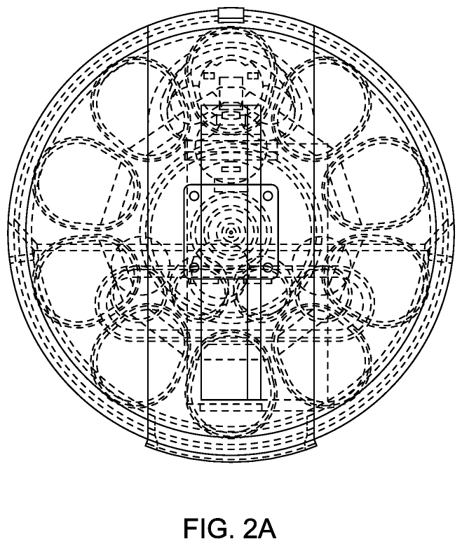

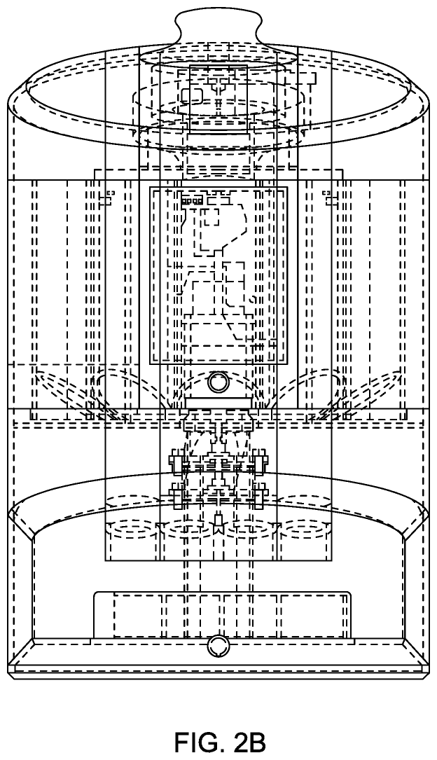

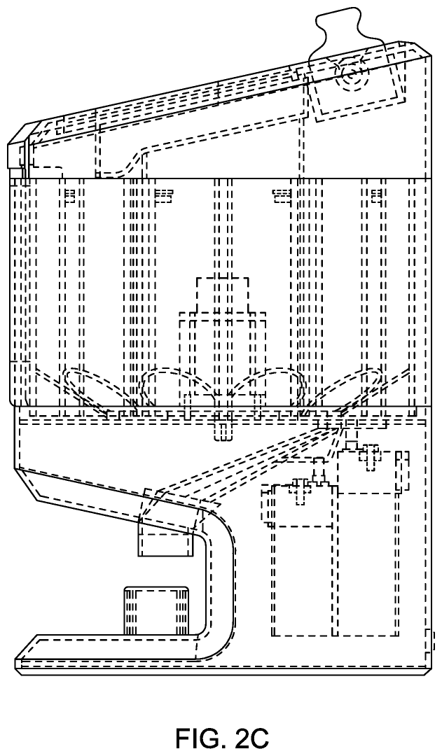

FIGS. 2A-2C show various perspectives of a schematic depiction of an exemplary solid medication dispensing device according to an embodiment of the present application. FIG. 2A shows a top-down view. FIG. 2B shows a frontal view. FIG. 2C shows a side-on view. The exemplary embodiment depicted in FIGS. 2A-2C shows a distributing adapter having four channels disposed above the removable storage compartment. Such a distributing adapter is configured to be used with a removable storage compartment having four sub-compartments as shown in the figures. The distributing adapter can be useful for ensuring that a solid medication unit intended to be distributed to a specific sub-compartment is not accidentally placed in a different sub-compartment. The dispensing distributor is depicted as being able to pivot so as to deliver a solid medication unit to a portion of the distributing adapter that corresponds to a specific sub-compartment of the removable storage compartment. It should be understood that the distributing adapter can have any suitable number of channels. It should be understood that the distributing adapter is not present in all embodiments.

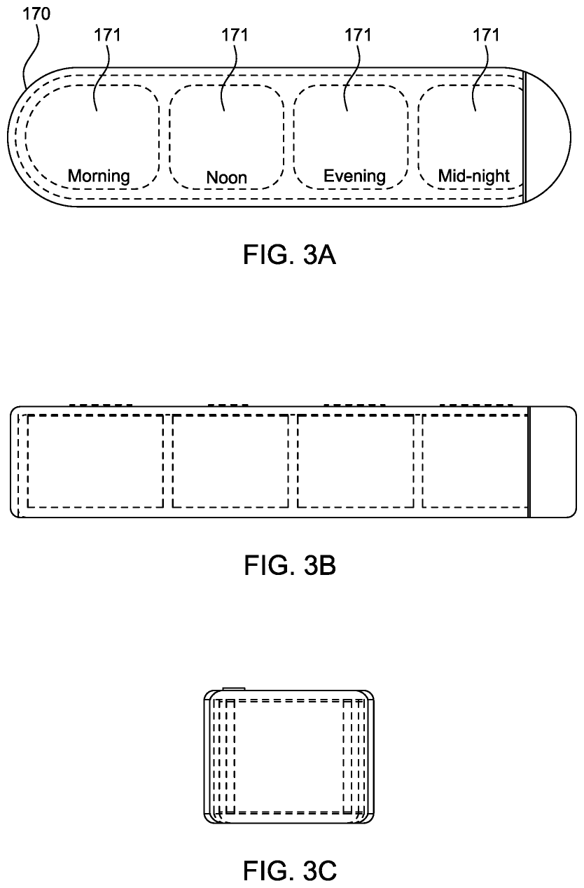

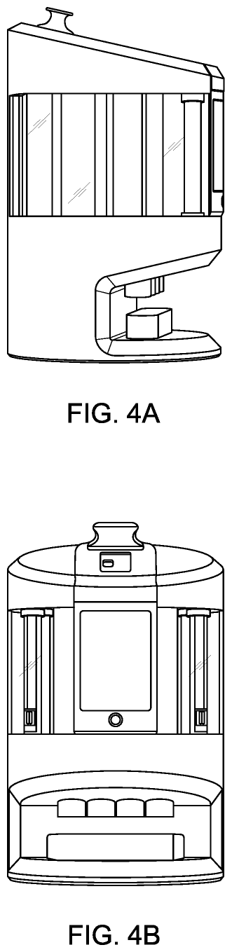

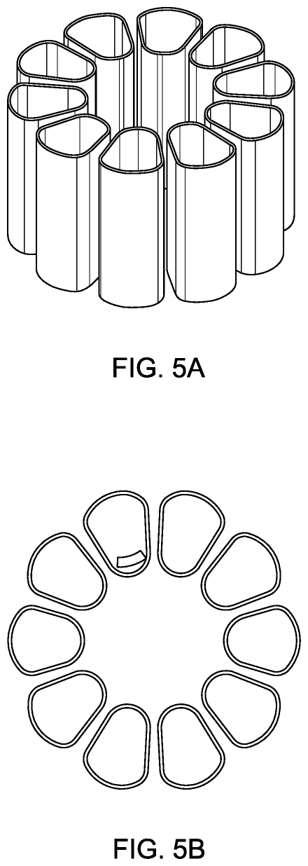

FIGS. 3A-3C show various perspectives of a schematic depiction of an exemplary removable storage compartment 170 according to an embodiment of the present application. The exemplary removable storage compartment depicted has four sub-compartments 171 labeled with different times of day (morning, noon, evening, and mid-night). The exemplary removable storage compartment depicted has a rounded rectangular prism shape, with a flat top and bottom faces, flat long faces, and rounded short faces. The exemplary removable storage compartment depicted includes a storage compartment cover having a similar overall shape into which the removable storage compartment slides. The storage compartment cover covers the sub-compartments 171 to prevent solid medication units from spilling out.

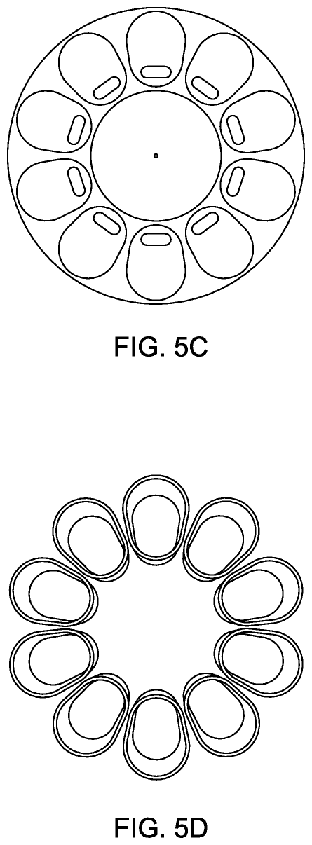

FIGS. 4A and 4B show renderings of an exemplary embodiment of a solid medication dispensing device according to the present specification with FIG. 4A showing a side-on view and FIG. 4B showing a frontal view.

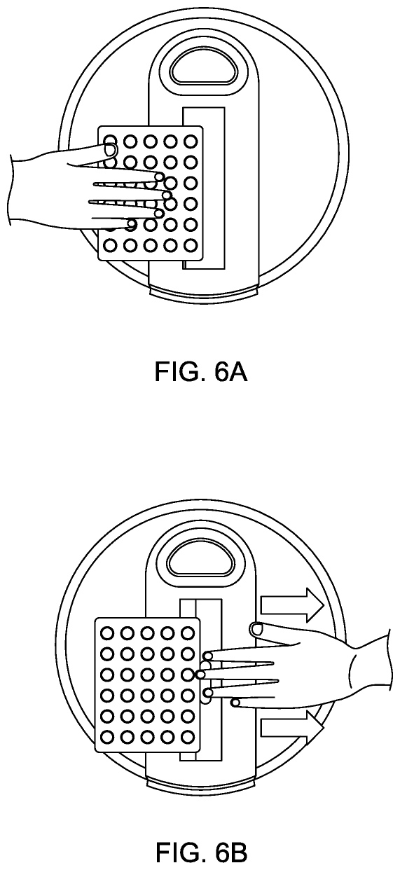

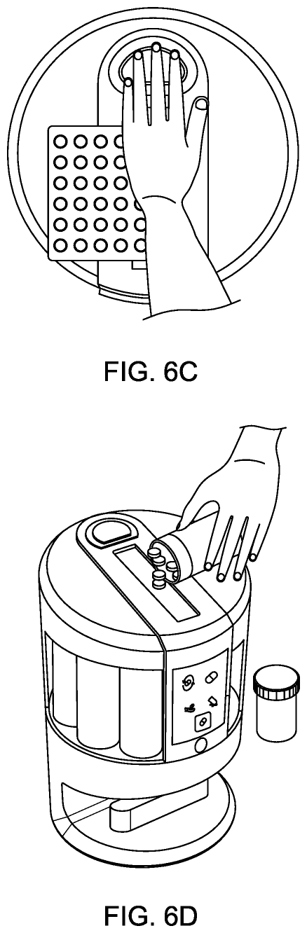

FIGS. 5A-5B show schematic depictions of an exemplary embodiment of solid medication holding chambers according to the present specification with FIG. 5A showing a three-quarters view and FIG. 5B showing a top-down view. The depicted holding chambers have an ovoid cross-sectional shape. The smaller end of the ovoid cross-sectional shape of the holding chambers is oriented toward a common center to form the medication carousel. The carousel is formed from 10 such holding chambers.

FIGS. 5C-5D show photographs of an exemplary embodiment of a medication carousel according to the present specification with FIG. 5C showing a carousel base and FIG. 5D showing a carousel having a plurality of solid medication holding chambers.

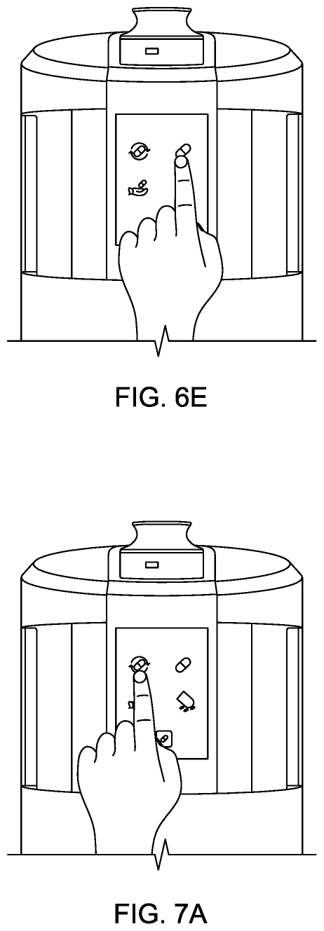

FIGS. 6A-6E show exemplary possible methods of filling the solid medication holding chamber with a solid medication. FIGS. 6A-6C show a method of filling with a medication from a blister pack. The figures show a user positioning the blister pack above the filling opening, opening the filling opening cover to an appropriate width, then pressing the blister pack to force the solid medication out with the aid of the blister pack opener. FIG. 6D shows a method of filling with a medication from a medication bottle. FIG. 6E shows a user entering information related to the medication added during the filling. The user is shown entering information via a touchscreen integral with the solid medication dispensing device.

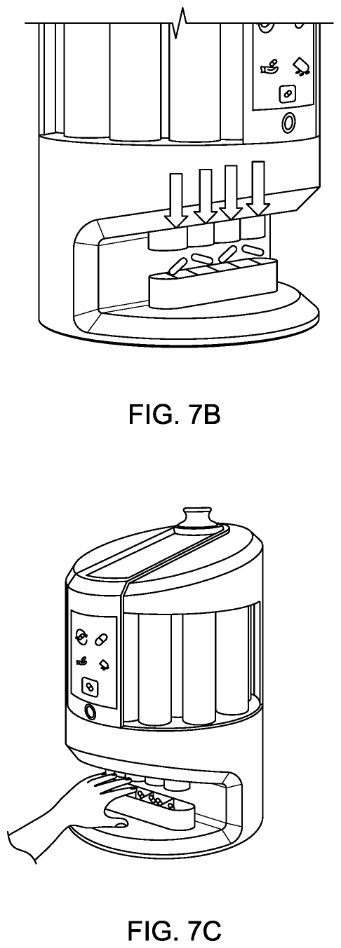

FIGS. 7A-7 shows an exemplary user-initiated dispensing action. FIG. 7A shows a user initiating a dispensing action on a touchscreen integral with the device. FIG. 7B shows the solid medications being distributed to various sub-compartments of the removable storage compartment. It should be noted that for convenience and understanding regarding the sub-compartments, the solid medications are shown being distributed simultaneously, but such simultaneous delivery of multiple medications is for illustration only. FIG. 7C shows a user retrieving the removable storage compartment filled with the solid medications.

1. A solid medication dispensing device, comprising
a dispenser body comprising
a body cover,
a baseplate comprising a dispensing opening,
a medication carousel including a plurality of solid medication holding chambers, each configured to contain a single type of solid medication, the medication carousel configured to be rotated relative to the dispensing opening,
a controllable opening cover configured to in a closed state block the dispensing opening and thereby prevent a solid medication from exiting a solid medication holding chamber and in an open state allow a solid medication to exit a solid medication holding chamber, and
a dispensing distributor disposed beneath the controllable opening cover;
a removable storage compartment; and
a controller, wherein
the dispensing distributor is configured to direct solid medication from the dispensing opening to the removable storage compartment;
the medication carousel is configured to rotate to position a solid medication holding chamber above the dispensing opening to permit dispensing of solid medication from that solid medication holding chamber during a dispensing action; and
the controller is configured to control a rotation of the medication carousel and an action of the controllable opening cover during the dispensing action such that a solid medication output including one or more solid medications from one or more solid medication holding chambers is provided to the removable storage compartment.

2. The solid medication dispensing device of claim 1, further comprising
a filling distributor configured to receive a solid medication input and distribute the solid medication input to a solid medication holding chamber during a filling action,
wherein the controller is configured to control to which solid medication hold chamber the solid medication input is distributed by controlling at least one selected from the group consisting of the filling distributor and the medication carousel.

3. The solid medication dispensing device of claim 1, wherein the removable storage compartment comprises a plurality of sub-compartments and the dispensing distributor is configured to direct a first portion of the solid medication output to a first sub-compartment and a second portion of the solid medication output to a second sub-compartment.

4. The solid medication dispensing device of claim 3, wherein the controller is configured to control an orientation of the dispensing distributor to direct the portion of the solid medication output to the sub-compartment.

5. The solid medication dispensing device of claim 1, further comprising an electronic user input device configured to receive user input and provide instructions to the controller based on the user inputs.

6. The solid medication dispensing device of claim 1, wherein the controller is configured to receive an identity of a solid medication held in a solid medication holding chamber.

7. The solid medication dispensing device of claim 1, wherein the controller is configured to receive a size of a unit of a solid medication held in a solid medication holding chamber.

8. The solid medication dispensing device of claim 7, wherein the controller is configured to adjust a position of the controllable opening cover to allow only a single unit of the solid medication held in the solid medication holding chamber to be dispensed at a time during a dispensing action.

9. The solid medication dispensing device of claim 1, wherein the controller is configured to receive a dosage schedule of a solid medication held in a solid medication holding chamber.

10. The solid medication dispensing device of claim 1, wherein the controller is configured to receive a receive a medication regimen and dispense one or more solid medications to the removable storage compartment based on the medication regimen.

11. The solid medication dispensing device of claim 10, wherein the medication regimen is a daily regimen and the solid medication dispensing device dispenses to the removable storage compartment an entirety of the daily regimen at one time.

12. The solid medication dispensing device of claim 11, wherein
the daily regimen is divided into one or more sub-regimens, each sub-regimen including at least one solid medication to be taken at a set time of day;
the removable storage compartment comprises a plurality of sub-compartments; and
each sub-regimen is dispensed to a different sub-compartment of the removable storage compartment.

13. The solid medication dispensing device of claim 10, wherein the medication regimen is a daily regimen and the solid medication dispensing device dispenses at a set time of day a sub-regimen including at least one solid medication to be taken at the set time of day.

14. The solid medication dispensing device of claim 2, wherein the body cover includes a filling opening configured to allow a solid medication to be supplied to the filling distributor.

15. The solid medication dispensing device of claim 14, wherein the body cover further comprises a blister pack opener.

16. A solid medication dispensing system, comprising
the solid medication dispensing device of claim 1; and
a portable electronic user device, wherein
the solid medication dispensing device is configured to receive user input from the portable electronic user device to provide an instruction to the controller based on the user input.

17. The solid medication dispensing system of claim 16, wherein the portable electronic user device is configured to provide an alert to a user.

18. The solid medication dispensing system of claim 16, wherein the portable electronic user device is configured to receive medication information including at least one of a size of a unit of a solid medication held in a solid medication holding chamber, a dosage schedule of a solid medication held in a solid medication holding chamber, and an identity of a solid medication held in a solid medication holding chamber; and
transmit the medication information to the controller.

19. The solid medication dispensing system of claim 16, wherein the controller is configured to track a quantity of units of a solid medication held in a solid medication holding chamber and transmit to the portable electronic user device a low medication alert when the quantity is at a threshold value.

20. The solid medication dispensing system of claim 16, wherein the portable electronic user device is configured to transmit to the controller a dispensing signal that causes the controller to initiate a dispensing action.
